(19) United States
(12) Patent Application Publication
(10) Pub. No.: US 2006/0129837 A1
(43) Pub. Date: Jun. 15, 2006

(54) Security device for home network and security configuration method thereof

(75) Inventors: Bum-jin Im, Yongin-si (KR); Kyung-hee Lee, Yongin-si (KR); Bae-eun Jung, Seongnam-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/296,266

(22) Filed: Dec. 8, 2005

(30) Foreign Application Priority Data
Dec. 9, 2004 (KR) 10-2004-0103430

(51) Int. Cl. H04K 1/00

(52) U.S. Cl. 713/184

(57) ABSTRACT

A security device for a home network and a security configuration method thereof. The security device for the home network includes a user interface to send at least one request signal that includes a device register request signal to register a home appliance to the home network; a public key generator to generate a public key and a password used for security configuration of the home network; a home appliance interface to interface with the home appliance; and a controller to control the home appliance interface to transmit the public key and the password to the home appliance, and the controller to control to register the home appliance to the home network according to a service discovery protocol when the device register request signal is received from the user interface. Accordingly, the security configuration of the home network can be facilitated.

### CROSS-REFERENCE TO RELATED APPLICATION

This application claims the benefit under 35 U.S.C. § 119 (a) from Korean Patent Application No. 10-2004-0103430 filed on Dec. 9, 2004 in the Korean Intellectual Property Office, the entire disclosure of which is incorporated herein by reference.

### BACKGROUND OF THE INVENTION

1. Field of the Invention

The present invention relates generally to a security device for a home network and a security configuration method thereof. More particularly, the present invention relates to a security device for configuring security of a home network system using a public key and a password that are generated at a security device, and a security configuration method thereof.

2. Description of the Related Art

A home network is an advanced home appliance system enabling a user to operate home appliances using a wireless security device such as mobile phones and personal Digital Assistance (PDS). Home appliances such as personal computers (PCs), televisions, refrigerators, and air conditioners, are connected via the home network and information can be transferred among the home appliances.

Typically, the home network is realized using an Internet Protocol (IP)-based private network, in which various types of home appliances are connected to each other and controlled over the network.

Protocols such as Home Audio/Video Interoperability (HAVi), Universal Plug and Play (UPnP), Jini, and Home Wide Web (HWW) have been suggested for the service discovery to allow communications between the various home appliances over the home network.

As for the UPnP, home appliances dynamically join the network, obtain their IP addresses, provide their functions, and recognize the presence and the function of the other appliances. Hence, the true zero configuration network can be implemented. The home appliances continue to communicate with each other directly, to thus reinforce the peer-to-peer networking function.

When establishing the home network with the UPnP, a security system construction of the home network is crucial to prevent an external intruder from operating the home appliances. However, in reality, the user has difficulty in managing the security due to the lack of the specialized knowledge relating to the characteristics of the home network deployed in home.

FIG. 1 is a conceptual diagram of a home network security system implemented with the conventional UPnP.

Referring to FIG. 1, the conventional home network security system includes a home appliance 10 capable of home networking, a control point (CP) 20 for controlling the home appliance 10 via the network, and a security console (SC) 30 responsible for the security function of the UPnP network.

To register a new home appliance 10 to the home network, the SC 30 informs the home appliance 10 that the SC 30 is an owner of the home network. Next, the CP 20 and the SC 30 exchange a public key and conduct the security function.

Generally, since the home appliance 10 is not equipped with an input device for inputting a key, the invariant public key and the password are embedded in the home appliance 10 at the manufacturing phase.

If the public key and the password are exposed to an external intruder, the external intruder can randomly control the operation and the access with respect to the home appliance 10. For example, the external intruder may arbitrarily change the owner of the home appliance 10. As a result, the security of the home appliance 10 is of no use, and the security function is not provided at all afterward.

In addition, if the database of the public key and the password managed by the manufacturer is attacked and exposed to the external intruder, a large-scale recall may arise against the manufacturer.

### SUMMARY OF THE INVENTION

Additional aspects and/or advantages of the invention will be set forth in part in the description which follows and, in part, will be apparent from the description, or may be learned by practice of the invention.

The present invention has been provided to solve the above-mentioned and other problems and disadvantages occurring in the conventional arrangement, and an aspect of the present invention provides a method for configuring security of a home network using a public key and a password, which are given unilaterally, at a security device when a home appliance is registered to the home network.

To achieve the above aspects and/or features of the present invention, a security device for a home network includes a user interface to send at least one request signal that includes a device register request signal to register a home appliance to the home network; a public key generator to generate a public key and a password used for security configuration of the home network; a home appliance interface to interface with the home appliance; and a controller to control the home appliance interface to transmit the public key and the password to the home appliance, and the controller to control to register the home appliance to the home network according to a service discovery protocol when the device register request signal is received from the user interface.

The home appliance interface may transmit the public key and the password via a location limited channel.

The security device may further include a memory to store the public key and the password that are generated at the public key generator.

The security device may further include a control device interface to exchange public keys with a control device that controls the home appliance.

The service discovery protocol may be a universal plug and play (UPnP).

According to another aspect of the present invention, a security configuration method of a security device for a home network includes generating a public key for security configuration of the home network; generating a password corresponding to the public key and transmitting the public key and the password when a device register request signal for registering a home appliance to the home network is received; and operating to register the home appliance to the home network.

The public key and the password may be transmitted via a location limited channel.

The home appliance may be registered to the home network according to a Universal Plug and Play (UPnP) protocol.

The security configuration method may further include exchanging public keys with a control device that controls the home appliance.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of exemplary embodiments, taken in conjunction with the accompanying drawing figures of which:

FIG. 1 is a conceptual diagram of a security system of a home network implemented with a conventional Universal Plug and Play (UPnP);

FIG. 2 is a block diagram of a security system of a home network according to one embodiment of the present invention;

FIG. 3 is a flowchart explaining a security configuration method of the home network security system of FIG. 2;

FIG. 4 is a flow diagram illustrating message transmission and reception for the security configuration method of FIG. 3;

FIG. 5 is a block diagram of a home network security system according to another embodiment of the present invention;

FIG. 6 is a flowchart explaining a security configuration method of the home network security system of FIG. 5; and

FIG. 7 is a flow diagram illustrating message transmission and reception for the security configuration method of FIG. 6.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

FIG. 2 is a block diagram of a security system of a home network according to one embodiment of the present invention.

The security system of the home network includes a security device 100 for configuring security of the home network, a home appliance 200 registered to the home network, and a control device 300 for controlling the home appliance 200.

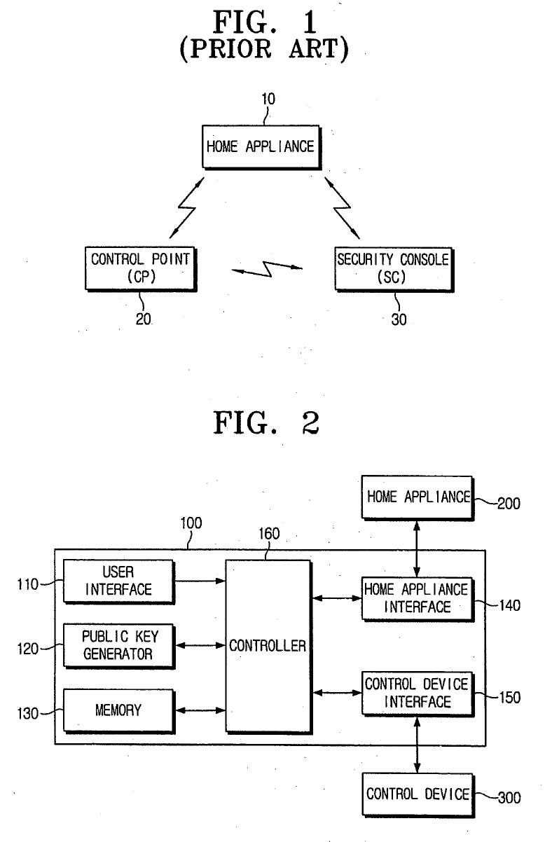

The security device 100 is provided for the security configuration of the home network. The security device 100 may be a portable wireless security device such as mobile phones and personal digital assistants (PDAs). Herein, the security device 100 corresponds to the security console (SC) 30 of the conventional home network security system as illustrated in FIG. 1. The security device 100 has its own public key.

The home appliance 200 is a next-generation home appliance such as audio and/or video devices, PCs, refrigerators, and washing machines, and is capable of communicating data over a wired and/or wireless network. Herein, the home appliance 200 refers to a new device to be registered to the home network.

The control device 300 controls the home appliance 200 registered to the home network. Similarly to the security device 100, the control device 300 may be a portable wireless security device such as mobile phones and the PDAs. Herein, the control device 300 corresponds to the control point (CP) 200 of the conventional home network security system as illustrated in FIG. 1. The control device 300 also has its own public key.

In FIG. 2, the security device 100 includes a user interface 110, a public key generator 120, a memory 130, a home appliance interface 140, a control device interface 150, and a controller 160.

The user interface 110 provides the controller 160, to be explained, with at least one request signal including a device register request signal to register the home appliance 200 to the home network. The user interface 110 may include key input means or electromagnetic sensing means depending on the type of the security device 100.

The public key generator 120 generates a public key of the home appliance 200 for the security configuration of the home network, and generates a random password corresponding to the public key. It takes much time for the public key generator 120 to generate the public key. Thus, the public key is generated in advance while the security device 100 is idle according to an embodiment of the present invention. Since the time taken to generate the password is less than the time taken to generate the public key, the password may be generated upon the request. It is also understood that the public key is generated when the security device is active.

The public key of an asymmetric cryptographic key pair for the public key cryptography system is made public. In specific, the public key cryptography algorithm uses an encryption key for encrypting data and a decryption key for recovering the original data, in which the encryption key is different from the decryption key. The public key cryptography algorithm is referred to as an asymmetric cryptography algorithm. According to the public key cryptography algorithm, even when the encryption key is made public, the original data cannot be obtained from the ciphertext because the decryption key is kept secret. In this sense, the encryption key is known as a public key, and the decryption key is known as a private key.

The memory 130 stores the public key generated at the public key generator 120. The pre-generated public key is stored in the memory 130 since it may take too much time for the public key generator 120 of the security device 110 to generate the public key. It is also understood that the memory can be connected to the security device 100 by a Universal Serial Bus (USB) port or IEEE 1394 port.

The home appliance interface 140 interfaces with the home appliance 200. According to one embodiment of the present invention, the home appliance interface 140 transfers the public key pair (public key and private key) to the home appliance 200 under the control of the controller 150. The public key pair and the password are transmitted via a location limited channel.

The control device interface 150 transfers the public key of the security device 100 to the control device 300 and receives the public key of the control device 300, to authorize the control device 300 to control the home appliance 200. In short, the security device 100 and the control device 300 exchange their own public keys with each other.

The controller 160, upon receiving the device register request signal from the user interface 110, controls to transmit the public key to the home appliance 200 via the home appliance interface 140. The public key may be generated by the public key generator 120 or pre-stored in the memory 130.

The controller 160 controls to register the home appliance 200 to the home network according to a service discovery protocol. The service discovery protocol is a Universal Plug and Play (UPnP) according to an aspect of the present invention. It is also understood that the service protocol can be anyone of HAVI, Jini, and HWW.

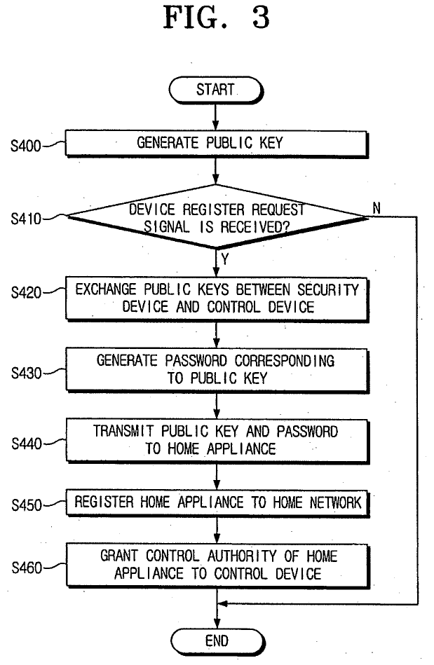

FIG. 3 is a flowchart explaining a security configuration method of the home network security system 100 of FIG. 2. Hereinafter, the security configuration method of the security device of the home network according to one embodiment of the present invention is described in reference to FIG. 2 and FIG. 3.

The public key generator 120 generates a public key (S400). Since the security device 100 and the control device 300 have their own public keys already, the generated public key is to be given to the home appliance 200.

Upon receiving the device register request signal via the user interface 110 according to the manipulation of the user (S410), the controller 160 transfers its public key to the control device 300 via the control device interface 150 and receives the public key of the control device 300 (S420).

The public key generator 120 generates a password corresponding to the public key to be given to the home appliance 200 (S430). The controller 160 controls to transmit the public key and the password to the home appliance 200 via the home appliance interface 140 (S440).

Next, the home appliance 200 is registered to the home network according to the UPnP (S450), and the control authority of the home appliance 200 is granted to the control device 300 (S460).

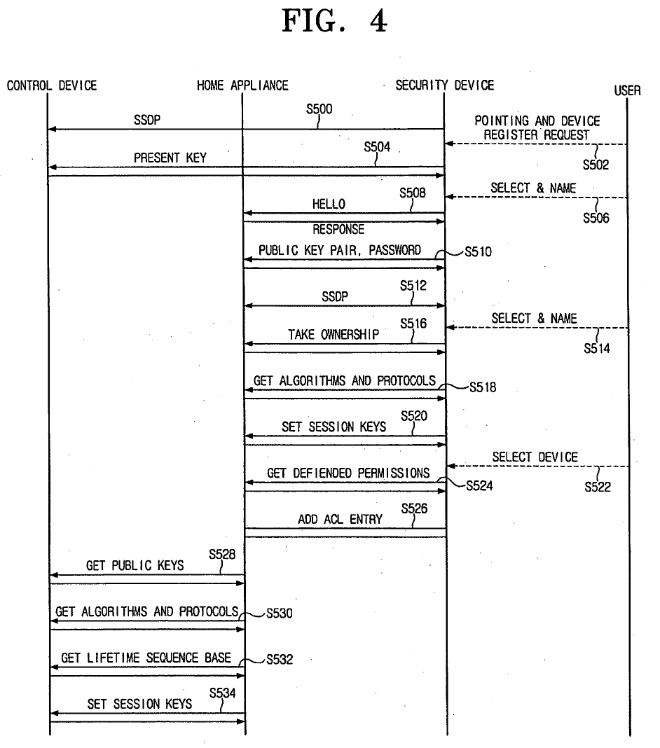

FIG. 4 is a flow diagram illustrating message transmission and reception for the security configuration method of FIG. 3.

The security device 100 and the control device 300 inform their presence according to the Simple Service Discovery Protocol (SSDP) (S500). When a new device is connected to the home network, the SSDP informs its presence using a SSDP message, and devices already connected in the home network receive the SSDP message and thus confirm that the new device is connected.

The user disposes the security device 100 in vicinity of the home appliance 200 or points the security device 100 to the home appliance 200 in the same signal transmission direction, and requests the device registration by manipulating the security device 100 (S502).

Upon receiving the device register request from the user, the security device 100 and the control device 300 exchange their own public keys using a Present Key message (S504).

After the public key exchange between the security device 100 and the control device 300, the user can randomly select a user definition name of the control device 300 in consideration of identification and usability of the name using a Select & Name message (S506). Alternatively the name of the control device may be generated automatically.

The security device 100 transmits a Hello message to the home appliance 200 to commence the communication with the home appliance 200, and the home appliance 200 receives the Hello message and responds with a Response message (S508).

The security device 100 transmits the public key pair and the password generated at the public key generator 120, to the home appliance 200 using a Public Key Pair, Password message (S510).

The security device 100 and the home appliance 200 inform their present using a SSDP message (S512). The user defines a user definition name of the home appliance 200 using a Select & Name message (S514). For instance, the user definition name may be a TV in a living room, a TV in a inner bedroom, a PC in a study room, and the like

The security device 100 informs that it is the owner by sending a Take Ownership message to the home appliance 200 (S516). According to the UPnP of the related art, the Take Ownership message is encrypted using the password as the key, and the password is input to the security device 100 directly by the user. The home appliance 200 upon receiving the Take Ownership message, decrypts the message using its password and permits the security device 100 as its owner when the message decryption succeeds.

The security device 100 sends a Get Algorithms And Protocols message to the home appliance 200 to confirm algorithms and protocols supported by the home appliance 200 (S518). Upon receiving the Get Algorithms And Protocols message, the home appliance 200 transmits a list of its supporting algorithms and protocols to the security device 100 (S518). The Get Algorithms And Protocols message is transmitted to ensure compatibility among home network devices produced by different manufactures.

The security device 100 sends a Set Session Keys message to the home appliance 200 (S520). The Set Session Keys message instructs to generate a one-time key used only for a relevant session. Also, the Set Session Keys message instructs the security device 100 to generate and provide a hash and a random character string to be used as the encryption key to the home appliance 200. Only the security device 100 can generate the Set Session Keys message and only the home appliance 200 is able to decrypt the message.

Next, the user selects an intended home appliance using a Select Device message by manipulating the security device 100 (S522).

Upon receiving a Get Defined Permissions message from the security device 100, the home appliance 200 transmits a set of its definable permissions (S524).

The security device 100 sends an Add ACL Entry message to the home appliance 200 to instruct to add the control device 300 into an access control list (ACL) (S526). A typical home appliance 200 has a database for the ACL entry and executes only a control command corresponding to a defined permission retrieved from the database upon receiving the control command from the control device 300.

The home appliance 200 transmits its public key to the control device 300 and the control device 300 also transmits its public key to the home appliance 200 using a Get Public Keys message (S528).

The home appliance 200 sends a Get Algorithms And Protocols message to the control device 300. The control device 300 upon receiving the message transmits a list of its supporting algorithms to the home appliance 200 (S530).

The home appliance 200 sends a Get Lifetime Sequence Base message to the control device 300 and receives a response (S532). The Get Lifetime Sequence Base message is to set sequential numbers to prevent a second attack. The sequential numbers prevents an attacker from reusing a previous message.

Lastly, the home appliance 200 sends a Set Session Keys message to the control device 300 (S534). As a result, only the control device 300 can decrypt the message received from the home appliance 200.

Operations S512 through S534 are the same as in the conventional security configuration method using the UPnP. Thus, detailed descriptions thereof are omitted for brevity.

Through the message transmission and reception among the security device 100, the home appliance 200, and the control device 300 at operations S500 through S534, the security configuration method as shown in FIG. 3 can be carried out.

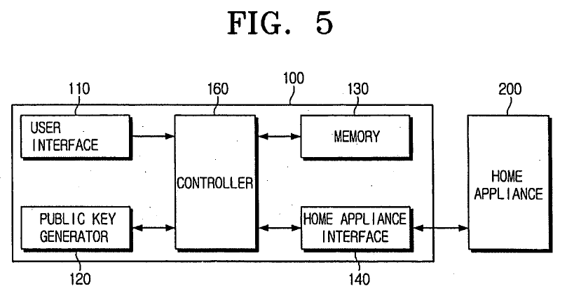

FIG. 5 is a block diagram of a home network security system according to another embodiment of the present invention. In comparison, in FIG. 2, the security device 100 corresponding to the SC 30 and the control device 300 corresponding to the CP 20 are provided respectively. The sole security device 100 in FIG. 5 functions as both the SC 30 and the CP 20, by way of example.

The home network security system according to another embodiment of the present invention is constructed similarly to one embodiment of the present invention. In the following, only different constructions are explained for conciseness, wherein like reference numerals refer to the like elements throughout.

As shown in FIG. 5, the home network security system according to another embodiment of the present invention includes the security device 100 and a home appliance 200.

The security device 100 includes a user interface 110, a public key generator 120, a memory 130, a home appliance interface 140, and a controller 160. Herein, the user interface 110, the public key generator 120, the memory 130, and the home appliance interface 140 function the same as the components in FIG. 2, and thus further descriptions thereof are omitted for brevity.

According to another embodiment of the present invention, the security device 100 needs to be able to control the home appliance 200. Hence, the controller 160 further functions to control the home appliance 200.

When a request signal to control the home appliance 200 is input via the user interface 110, the controller 160 generates a control signal corresponding to the received request signal. The controller 170 transmits the generated control signal to the home appliance 200 via the home appliance interface 140 to thus control the home appliance 200.

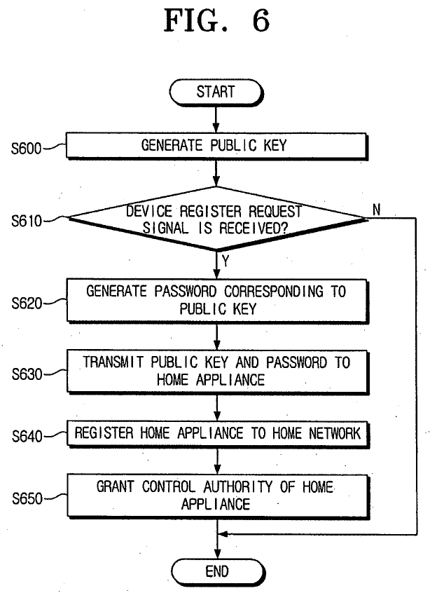

FIG. 6 is a flowchart explaining a security configuration method of the home network security system of FIG. 5. Hereinafter, the security configuration method of the home network security system according to another embodiment of the present invention is illustrated in reference to FIG. 5 and FIG. 6.

The public key generator 120 generates a public key to be given to the home appliance 10 in advance and stores the generated public key in the memory 130 (S600).

Upon receiving the device register request signal via the user interface 110 (S610), the public key generator 120 randomly generates the password corresponding to the public key given to the home appliance 200 (S620).

The controller 160 controls to transmit the public key and the password to the home appliance 200 via the home appliance interface 140 (S630). The home appliance 200 is registered to the home network according to the UPnP (S640). The controller 160 sets to grant the control authority of the home appliance 200 to the security device 100 (S650).

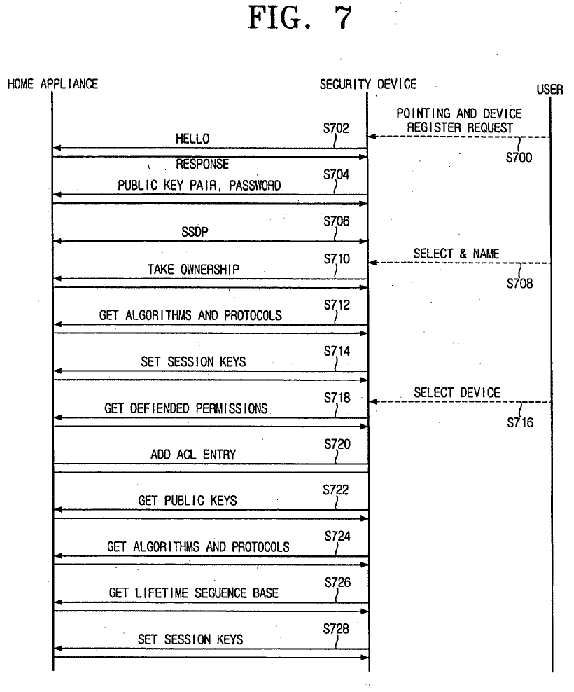

FIG. 7 is a flow diagram illustrating message transmission and reception for the security configuration method of FIG. 6.

The user disposes or points the security device 100 in vicinity of the home appliance 200 and requests the device registration by manipulating the security device 100 (S700).

The security device 100 sends a Hello message to the home appliance 200 to commence the communication with the home appliance 200. The home appliance 200 receives the Hello message and responds with a Response message (S702).

The security device 100 transmits the public key and the password, which are generated at the public key generator 120, to the home appliance 200 using a Public Key Pair, Password message, and then the home appliance 100 responds to this message (S704).

Messages transferred between the security device 100 and the home appliance 200 according to the UPnP at operation S706 through S728 are the same as the messages at operations S512 through S534 as explained in FIG. 4. Hence, further descriptions as to operations S706 through S708 are omitted for brevity.

In FIG. 7, the control device 300 is not provided as comparing with FIG. 4. Accordingly, the messages at operation S706 through S728 are transferred from the security device 100 to the home appliance 200, and the home appliance 200 transfers responses to the security device 100.

It is noted that the Add ACL Entry message at operation S720 indicates that the control authority of the home appliance 200 is given to the security device 100. The user defines a user definition name of the home appliance 200 at operation S708.

As for the security configuration method of the security device for the home network according to an embodiment of the present invention, it is understood that the control device 300 and the security device 100 may be equipped respectively, or, the security device 100 may combine the function of the control device 300.

In light of the foregoing as set forth above, the security device and the security configuration method for the home network according to an embodiment of the present invention, utilize the public key generated at the security device as the security key of the home appliance. Therefore, the network security can be configured with the simple manipulation.

Furthermore, the public key of the home appliance can be kept safe from attacks of an external intruder even when the public key database maintained by the manufacturer is exposed. More thorough security of the home network can be achieved.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A security device for a home network, the device comprising:
a user interface to send at least one request signal that includes a device register request signal to register a home appliance to the home network;
a public key generator to generate a public key and a password used for security configuration of the home network;
a home appliance interface to interface with the home appliance; and
a controller to control the home appliance interface to transmit the public key and the password to the home appliance, and the controller to control to register the home appliance to the home network according to a service discovery protocol when the device register request signal is received from the user interface.

2. The security device according to claim 1, wherein the home appliance interface transmits the public key and the password via a location limited channel.

3. The security device according to claim 1, further comprising:
a memory to store the public key and the password that are generated at the public key generator.

4. The security device according to claim 1, further comprising:
a control device interface to exchange public keys with a control device that controls the home appliance.

5. The security device according to claim 1, wherein the service discovery protocol is one of a universal plug and play (UPnP), Home Audio/Video Interpretability (HAVi), Jini, and Home Wide Web (HWW).

6. The security device according to claim 1, wherein the device is one of a mobile phone and personal digital assistant (PDA).

7. The security device according to claim 1, wherein the public key is generated during the device is idle.

8. The security device according to claim 1, wherein a user definition name of the home appliance is generated by a user.

9. A security configuration method of a security device for a home network, the method comprising:
generating a public key for security configuration of the home network;
generating a password corresponding to the public key and transmitting the public key and the password to a home appliance when a device register request signal for registering the home appliance to the home network is received; and
operating to register the home appliance to the home network.

10. The security configuration method according to claim 6, wherein the public key and the password are transmitted via a location limited channel.

11. The security configuration method according to claim 6, wherein the home appliance is registered to the home network according to a Universal Plug and Play (UPnP) protocol.

12. The security configuration method according to claim 6, further comprising:
exchanging public keys with a control device that controls the home appliance.

13. The security configuration method according to claim 6, wherein the public key is generated during the device is idle.
